(19) United States
(12) Patent Application Publication
(10) Pub. No.: US 2011/0297402 A1
(43) Pub. Date: Dec. 8, 2011

(54) Fire-Suppressing Ceiling Panels

(76) Inventors: Cesar Belmonte, Cordova, TN (US); Eduardo Talbert, Germantown, TN (US)

(21) Appl. No.: 13/152,180

(22) Filed: Jun. 2, 2011

Related U.S. Application Data
(60) Provisional application No. 61/351,199, filed on Jun. 3, 2010.

(51) Int. Cl. A62C 3/00

(52) U.S. Cl. 169/56

(57) ABSTRACT

Fire-suppressing ceiling panels compatible with standard ceiling materials like gypsum drywall and drop-in suspended ceiling panels, which provide improved structural integrity and ease of installation while providing for long-term isolation of fire suppression agents from moisture. Various embodiments are disclosed.

### BACKGROUND OF THE INVENTION

A variety of automatic fire suppression systems for structures are known in the art, the most common of which are fire sprinklers that release water from overhead pipes in response to the heat of a fire melting a fusible valve. Other systems which release finely divided fire-suppressing solids in response to the heat of a fire have been proposed, but although such systems have an advantage over fire sprinklers by not requiring extensive plumbing and a source of water pressure to operate, they have had significant limitations as well, both aesthetically and technically, in that they may not be compatible with or do not resemble standard materials like gypsum drywall or conventional drop-in suspended ceiling tiles, and do not adequately provide for the long-term isolation from moisture of the fire suppressing agents, which are often hygroscopic chemicals.

Further, replacement of large portions of the internal volume of a ceiling panel with flowable powder reduces its structural integrity in the absence of an alternative structure to provide support to the weight of the powder, which may result in sagging of the panels, or even structural failure and resulting undesired release of the powder. The problem of undesired release of powder also hampers installation, because cutting the panels to a desired size, as is often done in drywall installation, risks releasing the fire suppression agent. Having large areas of unsupported structure makes fastening the panel to ceiling joists more difficult, by limiting the points at which fasteners may pierce the panel without releasing the fire suppression agent, and by reducing the strength of certain attachment points.

A need therefore exists in the art for a fire-suppressing ceiling panel system that is compatible with standard ceiling materials like gypsum drywall and drop-in suspended ceiling panels, which provides for long-term isolation of fire suppression agents from moisture, and which provides improved structural integrity and ease of installation.

### BRIEF DESCRIPTION OF THE DRAWINGS

FIG. 1 A partially exploded perspective view of fire-suppressing suspended ceiling panels constructed according to an embodiment of the invention.

FIG. 2 A partially exploded perspective view of fire-suppressing suspended ceiling panels constructed according to an embodiment of the invention.

FIG. 3 A partially exploded perspective view of fire-suppressing drywall panels constructed according to an embodiment of the invention.

FIG. 4 A partially exploded perspective view of fire-suppressing drywall panels constructed according to an embodiment of the invention.

FIG. 5 A partially exploded perspective view of fire-suppressing drywall panels constructed according to an embodiment of the invention.

FIG. 6 A partially exploded perspective view of fire-suppressing suspended ceiling panels constructed according to another embodiment of the invention.

FIG. 7 A partially exploded perspective view of fire-suppressing drywall panels constructed according to another embodiment of the invention.

FIG. 8 A partially exploded perspective view of fire-suppressing drywall panels constructed according to another embodiment of the invention.

FIG. 9 A detail perspective view illustrating the release of the cap of a single fire suppressing cell according to an embodiment of the invention.

FIG. 10 A detail perspective view illustrating the deployment of a tethered packet from a single fire suppressing cell following release of the cap according to an embodiment of the invention.

FIG. 11 A detail perspective view of an alternative cell framework including integral attachment points for fastener installation, according to an embodiment of the invention.

FIG. 12 A partially exploded perspective view illustrating an installation technique for fire-suppressing drywall panels constructed according to an embodiment of the invention.

FIG. 13a A schematic representation of a manufacturing process for producing fire suppressing drywall panels according to an embodiment of the invention.

FIG. 13b A schematic representation of a manufacturing process for producing fire suppressing drywall panels according to another embodiment of the invention.

### DETAILED DESCRIPTION OF THE DRAWINGS

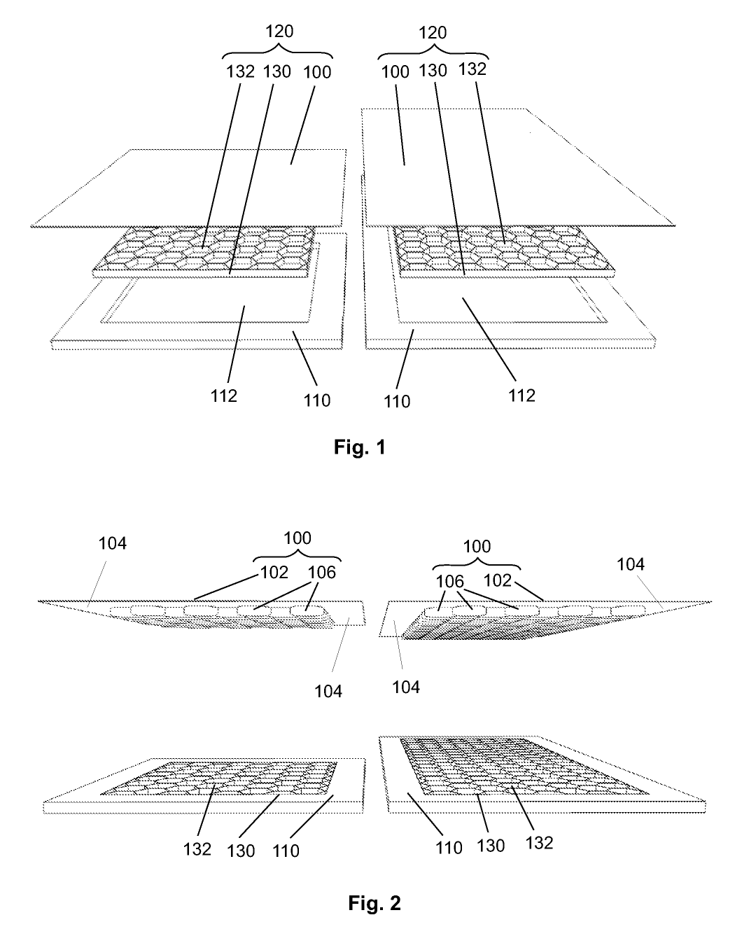

FIG. 1 depicts a partially exploded perspective view of fire-suppressing suspended ceiling panels constructed according to an embodiment of the invention. The embodiment shown can be referred to as a “Type I” fire-suppressing suspended ceiling panel. The perspective shown is that looking downward at an oblique angle at the bottom face of the panel, in order to illustrate the manner of assembly. When installed in a suspended ceiling grid, the bottom face of the panel in this embodiment, which comprises a unitary fusible facing layer 100 would be facing downward towards the floor of the room or other space to be protected from fire. Fire-suppressing suspended ceiling panels constructed according to the present invention may be made in variety of sizes, shapes, and thicknesses as necessary to accommodate different ceiling grid systems and fire-suppression requirements. Examples of two different standard sizes and shapes are shown, but other shapes, sizes, and thicknesses may be used without departing from the scope and spirit of the invention.

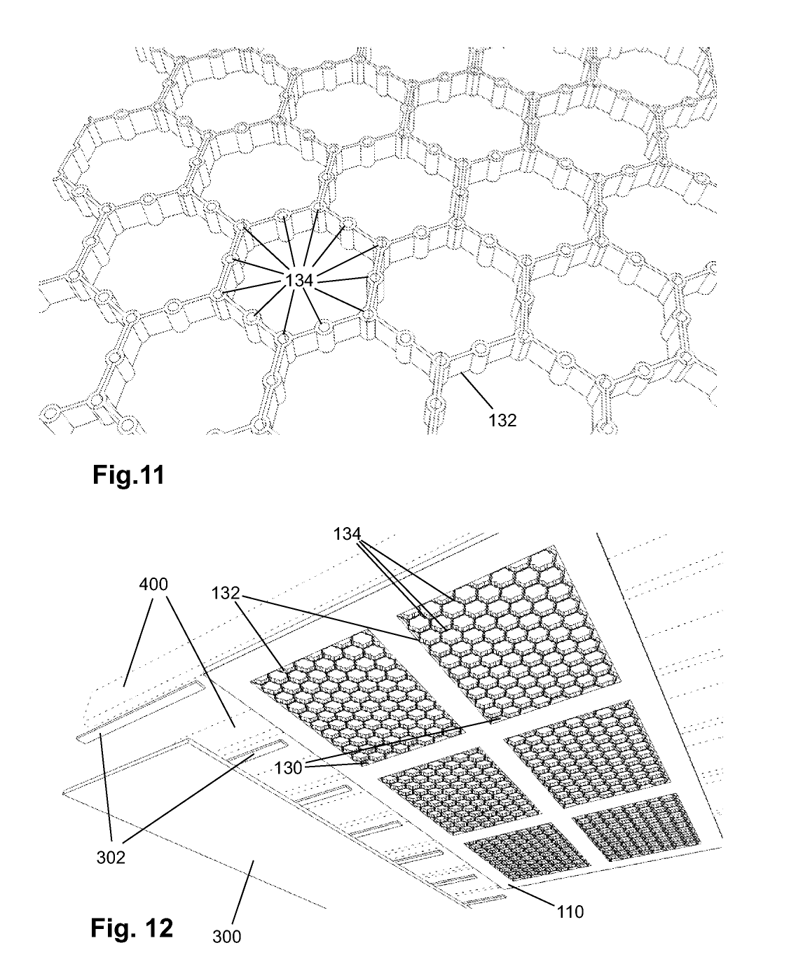

Fire-suppressing suspended ceiling panels constructed according to one embodiment of the present invention comprise a frame 110, having at least one void 112, and a fire suppressing unit 120 mounted into each void 112. The frame 110 can be made of conventional suspended ceiling panel materials as are known in the art, such as “mineral wool” (a.k.a. “rock wool” or “slag wool”), cellulose fibers, gypsum, perlite, starch, clay, fiberglass, and other additives, such as flocculating and dispersion agents. The voids 112 in the frame 110 may be formed by any suitable method, such as casting, die cutting, stamping, or routing, and in a preferred embodiment are formed by casting in an analogous manner to that shown in FIG. 11a and FIG. 11b for the fire-suppressing drywall panels. Forming similar voids or “pockets” in conventional ceiling tile materials for the purpose of embedding electronic transceivers is described in U.S. Pat. No. 6,715,246.

According to a “Type I” embodiment of the invention, the fire-suppressing unit 120 that is mounted in the void 112 in the frame 110, can comprise a tray 130 containing a internal framework 132 and a unitary fusible facing layer 100 configured to be attached in a complementary fashion to the internal framework 132 and the frame 110. In a preferred embodiment, the internal framework 132 forms an array of honeycomb-like hexagonal cells, however, the internal framework 132 may be configured to form an array of cells of other shapes, such as triangular, square, rectangular, or diamond shapes. Similarly, the tray 130 may be formed in other shapes besides the square or rectangular shapes shown here, without departing from the scope and spirit of the invention. The tray 130 and internal framework 132 can be formed of any suitable lightweight and rigid material having sufficient strength to provide structural support to the unitary fusible facing layer 100, and which has a higher melting and/or combustion temperature than the material from which the unitary fusible facing layer 100 is constructed. Suitable materials for construction of the tray 130 and internal framework 132 include cardboard, paper, plastic, metal, or laminated or composite materials, such as metal foil laminates or fiberglass. The tray 130 and/or the internal framework 132 may be mounted to the frame 110 by any suitable method, such as adhesives or mechanical fasteners, or may be directly bonded to the frame 110 during the manufacturing process for the frame 110, provided that the tray 130 and/or internal framework 132 are formed of materials compatible with the manufacturing process for the frame 110.

The unitary fusible facing layer 100, as better illustrated in FIG. 2, comprises a fusible layer 102, and a plurality of fire suppression packets 106 which may be formed integrally to the fusible layer 102, and which contain a fire suppressing chemical agent.

The fire suppression packets 106 are configured to be mounted within the cells of the internal framework 132, and the fusible layer 102 forms the bottom surface of the fire suppressing suspended ceiling panel. The fusible layer 102 and the fire suppression packets 106 may be formed of any suitable low melting point plastic that is durable and has a low permeability to water vapor, such as polyethylene or polypropylene. The fusible layer 102 and the fire suppression packets 106 may be attached to the internal framework 132 and the frame 110 by any suitable method, including adhesives or mechanical fasteners, provided that the attachment method remains strong at temperatures above the point at which the fusible layer 102 and the fire suppression packets 106 fuse and release the fire suppressing chemical agent. The materials from which the unitary fusible facing layer 100 is constructed are necessarily incompatible with high temperatures involved in the conventional manufacturing process for the frame 110, and so are attached at a later stage, after the frame 110 is sufficiently cooled and dry.

The fire suppressing chemical agent contained within the fire suppression packets 106 is preferably a powdered chemical fire extinguishing agent such as ABC powder or Purple K, and the sealed fire suppression packets 106 provide a barrier to moisture that could cause clumping or caking of these generally hygroscopic chemicals during their long term storage in the panel. Additional means to stabilize and ensure performance of the fire suppressing chemical agent, such as the addition of weighting agents, such as sand or calcium carbonate; desiccants, such as tricalcium phosphate, silica gel, diatomaceous earth, or acid-leached bentonite; and anti-caking agents, such as mica, attapulgite clay, or fumed silica; may be combined with the fire-suppressing chemicals.

FIG. 2 depicts a partially exploded perspective view of fire-suppressing suspended ceiling panels constructed according to an embodiment of the invention. In this view of the “Type I” fire-suppressing suspended ceiling panels, which, as in FIG. 1 are shown inverted to illustrate the manner of assembly, the fire suppression packets 106 on the upper surface of the unitary fusible facing layer 100 are visible, and the tray 130 and internal framework 132 are mounted in the frame 110. The fire suppression packets 106 containing the fire suppressing chemical agent are configured to be complementary to the cells in the internal framework 132, and the fusible layer 102 has a flange 104 which is configured to be complementary to the frame 110. When installed in a suspended ceiling grid, the bottom face of the panel in this embodiment, which comprises a unitary fusible facing layer 100 would be facing downward towards the floor of the room or other space to be protected from fire. During a fire, once the hot gases near the ceiling have reached a temperature sufficient to fuse the unitary fusible facing layer 100, the fire suppressing chemical agent contained within the fire suppression packets 106 would be released and fall downward onto the fire, suppressing or extinguishing it.

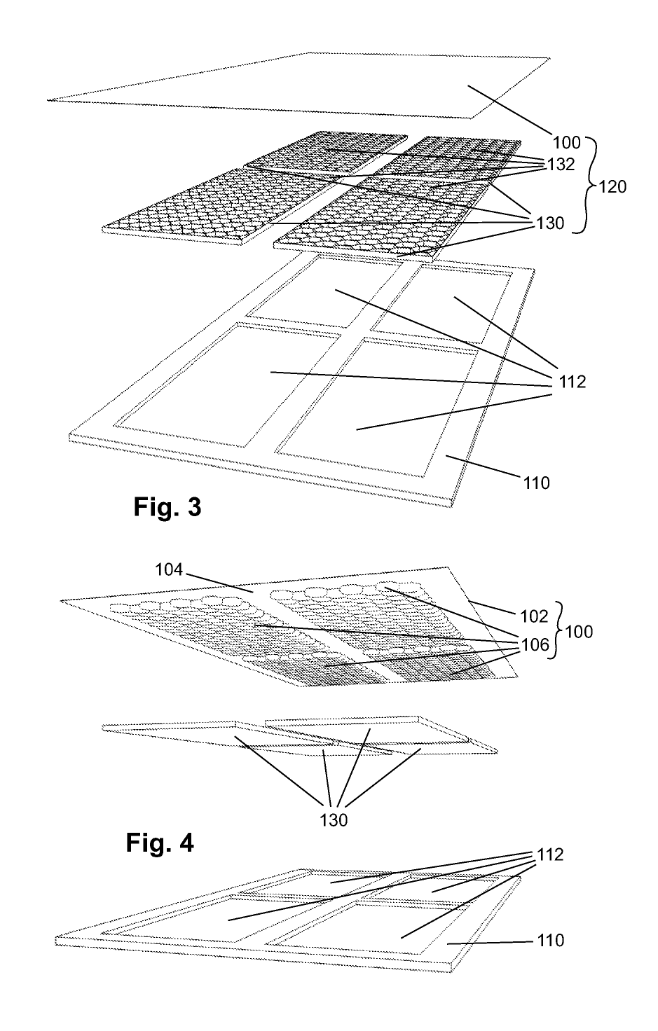

FIG. 3 depicts a partially exploded perspective view of fire-suppressing drywall panels constructed according to an embodiment of the invention. Similar to the “Type I” fire suppressing suspended ceiling panels, “Type I” fire-suppressing drywall panels may be constructed for use in hard ceiling applications. The perspective shown is that looking downward at an oblique angle at the bottom face of the panel, in order to illustrate the manner of assembly. When installed, the bottom face of the panel in this embodiment, which comprises a unitary fusible facing layer 100 would be facing downward towards the floor of the room or other space to be protected from fire. Although shown in a standard rectangular shape and size, and standard thickness, the fire-suppressing drywall panels may be made in variety of sizes, shapes, and thicknesses as necessary to accommodate different applications and fire-suppression requirements, without departing from the scope and spirit of the invention.

Fire-suppressing drywall panels constructed according to one embodiment of the present invention comprise a frame 110, having at least one void 112, and a fire suppressing unit 120 mounted therein. The frame 110 can be made of conventional drywall materials, such as gypsum and other additives as are known in the art, and may be bounded on the upper surface and sides by a layer of facing paper 114. The voids 112 in the frame 110 may be formed by any suitable method, such as casting, die cutting, stamping, or routing, and in a preferred embodiment are formed by casting as shown schematically in FIG. 11a and FIG. 11b. The voids 112 and bottom surface of the frame 110 may also be lined with facing paper or other material, such as a paper/plastic laminate, that enhances attachment of the fire suppressing unit 120 to the frame 110. In a preferred embodiment, the voids 112 in the fire-suppressing drywall panels are configured such that they will be located between standard ceiling joists, and the fire-suppressing drywall panel can be thus be mounted with conventional fasteners such as drywall screws or nails passing through the frame 110.

According to a “Type I” embodiment of the invention, the fire-suppressing unit 120 that is mounted in the voids 112 in the frame 110, can comprise one or more trays 130, one for each void 112, each containing a internal framework 132, and a unitary fusible facing layer 100 configured to be attached in a complementary fashion to the internal framework 132 of the trays 130 and the frame 110. In a preferred embodiment, the internal framework 132 forms an array of honeycomb-like hexagonal cells, however, the internal framework 132 may be configured to form an array of cells of other shapes, such as triangular, square, rectangular, or diamond shapes. Similarly, the tray 130 may be formed in other shapes besides the rectangular shapes shown here, without departing from the scope and spirit of the invention. The tray 130 and internal framework 132 can be formed of any suitable lightweight and rigid material having sufficient strength to provide structural support to the unitary fusible facing layer 100, and which has a higher melting and/or combustion temperature than the material from which the unitary fusible facing layer 100 is constructed. Suitable materials include cardboard, paper, plastic, metal, or laminated or composite materials, such as metal foil laminates or fiberglass. The tray 130 and/or the internal framework 132 may be mounted to the frame by any suitable method, such as adhesives or mechanical fasteners, or may be directly bonded to the frame 110 during the manufacturing process for the frame 110, provided that the tray 130 and/or internal framework 132 are formed of materials compatible with the manufacturing process for the frame 110.

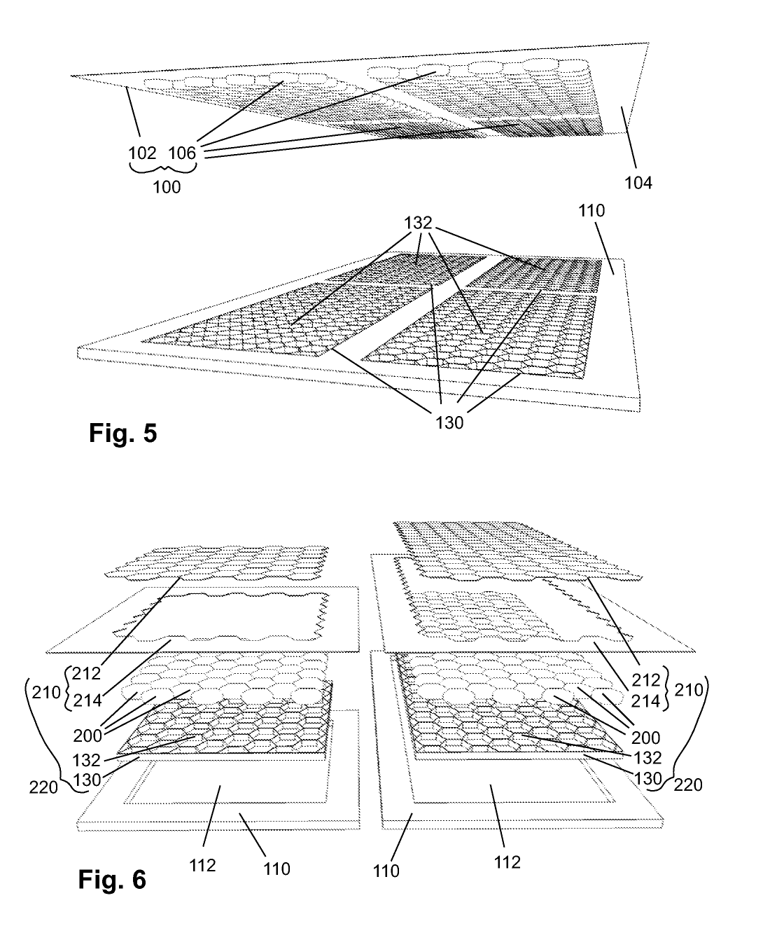

The unitary fusible facing layer 100, as better illustrated in FIGS. 4 and 5, comprises a fusible layer 102, and a plurality of fire suppression packets 106 which may be formed integrally to the fusible layer 102, and which contain a fire suppressing chemical agent.

The fire suppression packets 106 are configured to be mounted within the cells of the internal framework 132, and the fusible layer 102 forms the bottom surface of the fire suppressing drywall panel. The fusible layer 102 and the fire suppression packets 106 may be formed of any suitable low melting point plastic that is durable and has a low permeability to water vapor, such as polyethylene or polypropylene. The fusible layer 102 and the fire suppression packets 106 may be attached to the internal framework 132 and the frame 110 by any suitable method, including adhesives or mechanical fasteners, provided that the attachment method remains strong at temperatures above the point at which the fusible layer 102 and the fire suppression packets 106 fuse and release the fire suppressing chemical agent. The materials from which the unitary fusible facing layer 100 is constructed are necessarily incompatible with high temperatures involved in the conventional manufacturing process for the frame 110, and so are attached at a later stage, after the frame 110 is sufficiently cooled and dry.

The fire suppressing chemical agent contained within the fire suppression packets 106 is preferably a powdered chemical fire extinguishing agent such as ABC powder or Purple K, and the sealed fire suppression packets 106 provide a barrier to moisture that could cause clumping or caking of these generally hygroscopic chemicals during their long term storage in the panel. Additional means to stabilize and ensure performance of the fire suppressing chemical agent, such as the addition of weighting agents, such as sand or calcium carbonate; desiccants, such as tricalcium phosphate, silica gel, diatomaceous earth, or acid-leached bentonite; and anti-caking agents, such as mica, attapulgite clay, or fumed silica; may be combined with the fire-suppressing chemicals.

FIG. 4 depicts a partially exploded perspective view of fire-suppressing drywall panels constructed according to an embodiment of the invention. This view is another angle of the view shown in FIG. 3, and illustrates the location of the fire suppression packets 106 on the upper surface of the unitary fusible facing layer 100, and the complementary locations of the trays 130, and the voids 112 in the frame 110. The unitary fusible facing layer 100 has a flange 104 which borders the fire suppression packets 106 and is configured to be complementary to the frame 110.

FIG. 5 depicts a partially exploded perspective view of fire-suppressing drywall panels constructed according to an embodiment of the invention. In this view of the “Type I” fire-suppressing drywall panels, which, as in FIGS. 3 and 4 are shown inverted to illustrate the manner of assembly, the fire suppression packets 106 on the upper surface of the unitary fusible facing layer 100 are visible, and the trays 130, each containing a internal framework 132, are mounted in the frame 110. The fire suppression packets 106 containing the fire suppressing chemical agent are configured to be complementary to the cells of the internal framework 132, and the fusible layer 102 has a flange 104 which borders the fire suppression packets 106 and is configured to be complementary to the frame 110. When installed, the bottom face of the panel in this embodiment, which comprises a unitary fusible facing layer 100 would be facing downward towards the floor of the room or other space to be protected from fire. During a fire, once the hot gases near the ceiling have reached a temperature sufficient to fuse the unitary fusible facing layer 100, the fire suppressing chemical agent contained within the fire suppression packets 106 would be released and fall downward onto the fire, suppressing or extinguishing it.

FIG. 6 depicts a partially exploded perspective view of fire-suppressing suspended ceiling panels constructed according to another embodiment of the invention. The embodiment shown can be referred to as a “Type II” fire-suppressing suspended ceiling panel. The perspective shown is that looking downward at an oblique angle at the bottom face of the panel, in order to illustrate the manner of assembly. When installed in a suspended ceiling grid, the bottom face of the panel in this embodiment, which comprises a facing cap layer 210 would be facing downward towards the floor of the room or other space to be protected from fire. Fire-suppressing suspended ceiling panels constructed according to the present invention may be made in variety of sizes, shapes, and thicknesses as necessary to accommodate different ceiling grid systems and fire-suppression requirements. Examples of two different standard sizes and shapes are shown, but other shapes, sizes, and thicknesses may be used without departing from the scope and spirit of the invention.

In the embodiment illustrated here, the frame 110, and the tray 130 containing the internal framework 132 are similar to those shown in FIGS. 1 and 2. The Type II panels, like the Type I panels, comprise a frame 110, having at least one void 112, and a fire suppressing unit 120 mounted into each void 112. The frame 110 can be made of conventional suspended ceiling panel materials as are known in the art, such as “mineral wool” (a.k.a. “rock wool” or “slag wool”), cellulose fibers, gypsum, perlite, starch, clay, fiberglass, and other additives, such as flocculating and dispersion agents. The voids 112 in the frame 110 may be formed by any suitable method, such as casting, die cutting, stamping, or routing, and in a preferred embodiment are formed by casting in an analogous manner to that shown in FIG. 11a and FIG. 11b for the fire-suppressing drywall panels. Forming similar voids or “pockets” in conventional ceiling tile materials for the purpose of embedding electronic transceivers is described in U.S. Pat. No. 6,715,246.

According to a “Type II” embodiment of the invention, the fire-suppressing unit 220 that is mounted in the void 112 in the frame 110, can comprise a tray 130 containing a internal framework 132, individual sealed fusible packets 200 containing a fire suppressing chemical agent, which may be configured to be installed within the cells of the internal framework 132, and a facing cap layer 210, having an array of caps 212 configured to seal the cells of the internal framework 132 and a cap border 214 surrounding the caps 212, which forms the bottom surface of the fire-suppressing suspended ceiling panels. In a preferred embodiment, the internal framework 132 forms an array of honeycomb-like hexagonal cells, however, the internal framework 132 may be configured to form an array of cells of other shapes, such as triangular, square, rectangular, or diamond shapes. Similarly, the tray 130 may be formed in other shapes besides the square or rectangular shapes shown here, without departing from the scope and spirit of the invention. The tray 130 and internal framework 132 can be formed of any suitable lightweight and rigid material having sufficient strength to provide structural support to the individual sealed fusible packets 200, and which has a higher melting and/or combustion temperature than the material from which the individual sealed fusible packets 200 are constructed. Suitable materials for construction of the tray 130 and internal framework 132 include cardboard, paper, plastic, metal, or laminated or composite materials, such as metal foil laminates or fiberglass. The tray 130 and/or the internal framework 132 may be mounted to the frame by any suitable method, such as adhesives or mechanical fasteners, or may be directly bonded to the frame 110 during the manufacturing process for the frame 110, provided that the tray 130 and/or internal framework 132 are formed of materials compatible with the manufacturing process for the frame 110.

In the Type II panels, the fire suppressing chemical agent is contained within individual sealed fusible packets 200, which may be configured to be mounted within cells of the internal framework 132. A facing cap layer 210, having an array of caps 212 configured to seal the cells and a cap border 214 surrounding the caps 212, forms the bottom surface of the fire-suppressing suspended ceiling panels. The individual sealed fusible packets 200 may be formed of any suitable low melting point plastic that is durable and has a low permeability to water vapor, such as polyethylene or polypropylene. The caps 212 may be formed of any suitable rigid material having sufficient thickness and stability to seal the cells of the internal framework 132 without sagging or dimpling downwards due to gravity when the caps 212 are attached to the internal framework 132 at their perimeter. Suitable materials for forming the caps 212 include cardboard, paper, plastic, metal, or laminated or composite materials, such as metal foil laminates or fiberglass, as well as materials similar to that used for forming the frame 110. In a preferred embodiment, the caps 212 would be formed of materials similar to those used for forming the frame 110, such that the bottom surface of the “Type II” fire-suppressing suspended ceiling panel resembles to the greatest extent possible the bottom surface of a conventional suspended ceiling panel. The caps 212 may be attached to the internal framework 132 by any suitable method, such as a fusible or thermally sensitive adhesive or fusible or thermally sensitive mechanical fasteners which will release the caps 212 from the cells of the internal framework 132 at a temperature at or below the temperature at which the individual sealed fusible packets 200 fuse and release the fire suppressing chemical agent, but above the maximum temperatures that the panels would be exposed to in the absence of a fire. The cap border 214, for aesthetic reasons, will preferably be formed of the same material as the caps 212, but the attachment method selected to attach the cap border 214 to the frame and the periphery of the internal framework is intended to remain strong at temperatures above the point at which the individual sealed fusible packets 200 fuse and release the fire suppressing chemical agent.

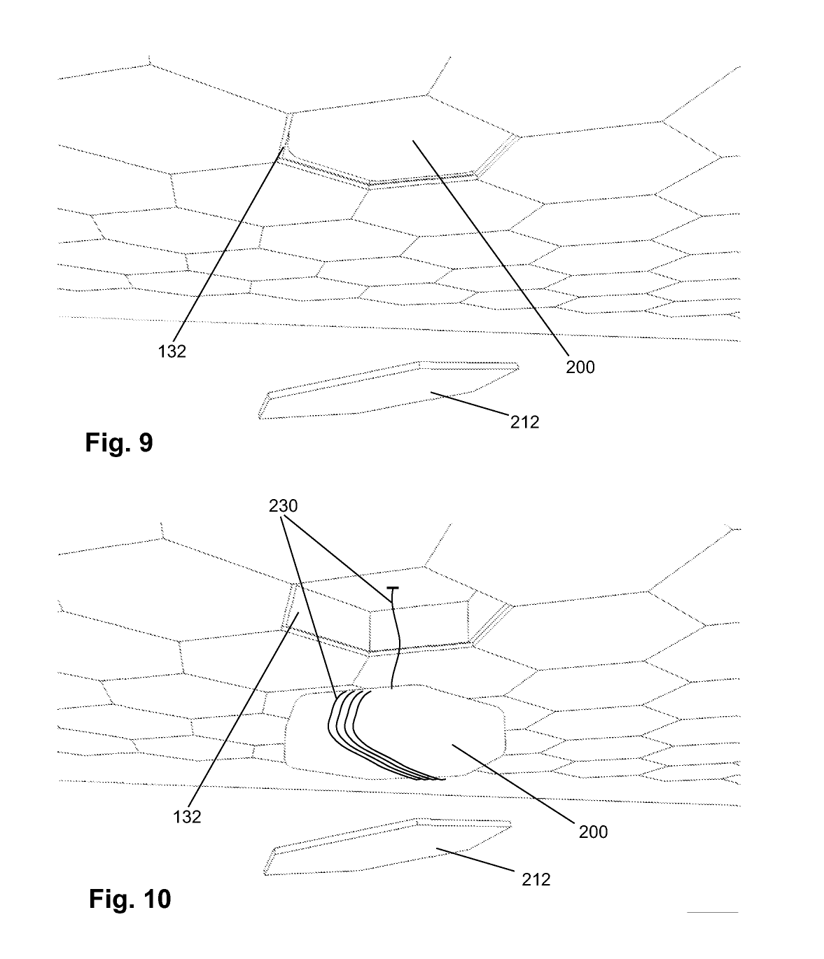

The individual sealed fusible packets 200 may be attached to the internal framework 132 by any suitable method, including adhesives or mechanical fasteners. In one embodiment of the Type II panels, as shown in FIG. 9, the attachment method selected to attach the individual sealed fusible packets 200 to the internal framework 132 is intended to remain strong at temperatures above the point at which the individual sealed fusible packets 200 fuse and release the fire suppressing chemical agent. In an alternative embodiment as shown in FIG. 10, the individual sealed fusible packets 200 are attached to the internal framework by a means such as a fusible or thermally sensitive adhesive or fusible or thermally sensitive mechanical fasteners which release the individual sealed fusible packets 200 from the cells of the internal framework 132 at a temperature at or below the temperature at which the individual sealed fusible packets 200 fuse and release the fire suppressing chemical agent. In this embodiment of the “Type II” panel, the attachment method used to attach the individual sealed fusible packets 200 to the cells of the internal framework 132 would preferably be selected to release the individual sealed fusible packets 200 from the cells of the internal framework 132 at a temperature at or below the temperature at which the caps 212 release from the cells of the internal framework 132, but above the maximum temperatures that the panels would be exposed to in the absence of a fire. The individual sealed fusible packets 200 are then deployed on a tether 230, which is configured to suspend the individual sealed fusible packets 200 at a preselected height above the fire, where they will release their fire-suppressing chemicals closer to the floor. The material from which the individual sealed fusible packets 200 are constructed are necessarily incompatible with high temperatures involved in the conventional manufacturing process for the frame 110, and so are attached at a later stage, after the frame 110 is sufficiently cooled and dry.

The fire suppressing chemical agent contained within the individual sealed fusible packets 200 is preferably a powdered chemical fire extinguishing agent such as ABC powder or Purple K, and the individual sealed fusible packets 200 provide a barrier to moisture that could cause clumping or caking of these generally hygroscopic chemicals during their long term storage in the panel. Additional means to stabilize and ensure performance of the fire suppressing chemical agent, such as the addition of weighting agents, such as sand or calcium carbonate; desiccants, such as tricalcium phosphate, silica gel, diatomaceous earth, or acid-leached bentonite; and anti-caking agents, such as mica, attapulgite clay, or fumed silica; may be combined with the fire-suppressing chemicals.

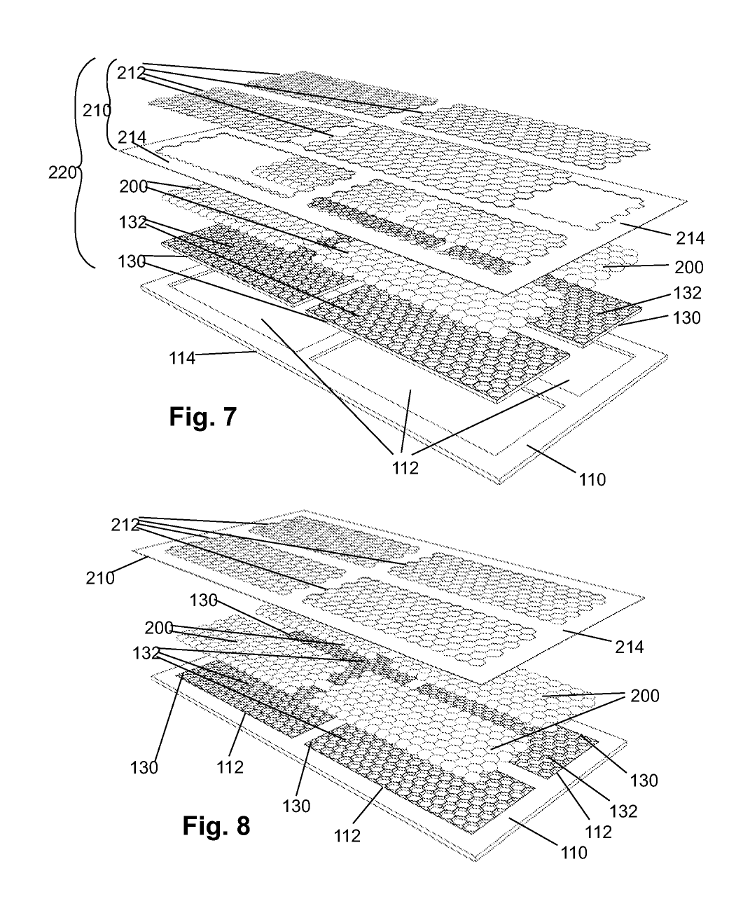

FIG. 7 depicts a partially exploded perspective view of fire-suppressing drywall panels constructed according to another embodiment of the invention. Similar to the “Type II” fire suppressing suspended ceiling panels, “Type II” fire-suppressing drywall panels may be constructed for use in hard ceiling applications. The perspective shown is that looking downward at an oblique angle at the bottom face of the panel, in order to illustrate the manner of assembly. When installed, the bottom face of the panel in this embodiment, which comprises a facing cap layer 210 would be facing downward towards the floor of the room or other space to be protected from fire. Although shown in a standard rectangular shape and size, and standard thickness, the fire-suppressing drywall panels may be made in variety of sizes, shapes, and thicknesses as necessary to accommodate different applications and fire-suppression requirements, without departing from the scope and spirit of the invention.

Fire-suppressing drywall panels constructed according to one embodiment of the present invention comprise a frame 110, having at least one void 112, and a fire suppressing unit 220 mounted therein. The frame 110 can be made of conventional drywall materials, such as gypsum and other additives as are known in the art, and may be bounded on the upper surface and sides by a layer of facing paper 114. The voids 112 in the frame 110 may be formed by any suitable method, such as casting, die cutting, stamping, or routing, and in a preferred embodiment are formed by casting as shown schematically in FIG. 11a and FIG. 11b. The voids 112 and bottom surface of the frame 110 may also be lined with facing paper or other material, such as a paper/plastic laminate, that enhances attachment of the fire suppressing unit 220 to the frame 110. In a preferred embodiment, the voids 112 in the fire-suppressing drywall panels are configured such that they will be located between standard ceiling joists, and the fire-suppressing drywall panel can be thus be mounted with conventional fasteners such as drywall screws or nails passing through the frame 110.

According to a “Type II” embodiment of the invention, the fire-suppressing unit 220 that is mounted in the voids 112 in the frame 110, can comprise one or more trays 130, one for each void 112, each containing a internal framework 132, individual sealed fusible packets 200 which may be configured to be installed within the cells of the internal framework 132, each packet containing a quantity of fire suppressing chemical agent, and a facing cap layer 210, having an array of caps 212 configured to seal the cells of the internal framework 132 and a cap border 214 surrounding the caps 212, which together with the facing cap layer 210 forms the bottom surface of the fire-suppressing drywall panels. In a preferred embodiment, the internal framework 132 forms an array of honeycomb-like hexagonal cells, however, the internal framework 132 may be configured to form an array of cells of other shapes, such as triangular, square, rectangular, or diamond shapes. Similarly, the tray 130 may be formed in other shapes besides the rectangular shapes shown here, without departing from the scope and spirit of the invention. The tray 130 and internal framework 132 can be formed of any suitable lightweight and rigid material having sufficient strength to provide structural support to the individual sealed fusible packets 200, and which has a higher melting and/or combustion temperature than the material from which the individual sealed fusible packets 200 are constructed. Suitable materials for construction of the tray 130 and internal framework 132 include cardboard, paper, plastic, metal, or laminated or composite materials, such as metal foil laminates or fiberglass. The tray 130 and/or the internal framework 132 may be mounted to the frame by any suitable method, such as adhesives or mechanical fasteners, or may be directly bonded to the frame 110 during the manufacturing process for the frame 110, provided that the tray 130 and/or internal framework 132 are formed of materials compatible with the manufacturing process for the frame 110.

In the Type II panels, the fire suppressing chemical agent is contained within individual sealed fusible packets 200, which may be configured to be mounted within cells of the internal framework 132. A facing cap layer 210, having an array of caps 212 configured to seal the cells and a cap border 214 surrounding the caps 212, forms the bottom surface of the fire-suppressing drywall panels. The individual sealed fusible packets 200 may be formed of any suitable low melting point plastic that is durable and has a low permeability to water vapor, such as polyethylene or polypropylene. The caps 212 may be formed of any suitable rigid material having sufficient thickness and stability to seal the cells of the internal framework 132 without sagging or dimpling downwards due to gravity when the caps 212 are attached to the internal framework 132 at their perimeter. Suitable materials for forming the caps 212 include cardboard, paper, plastic, metal, or laminated or composite materials, such as metal foil laminates or fiberglass. In a preferred embodiment, the caps 212 would be covered on their bottom surface with a layer of facing paper, such that the bottom surface of the “Type II” fire-suppressing drywall panel resembles to the greatest extent possible the bottom surface of a conventional drywall panel. The caps 212 may be attached to the internal framework 132 by any suitable method, such as a fusible or thermally sensitive adhesive or fusible or thermally sensitive mechanical fasteners which will release the caps 212 from the cells of the internal framework 132 at a temperature at or below the temperature at which the individual sealed fusible packets 200 fuse and release the fire suppressing chemical agent, but above the maximum temperatures that the panels would be exposed to in the absence of a fire. The cap border 214, for aesthetic reasons, will preferably be formed of the same material as the caps 212, but the attachment method selected to attach the cap border 214 to the frame and the periphery of the internal framework is intended to remain strong at temperatures above the point at which the individual sealed fusible packets 200 fuse and release the fire suppressing chemical agent.

The individual sealed fusible packets 200 may be attached to the internal framework 132 by any suitable method, including adhesives or mechanical fasteners. In one embodiment of the Type II panels, as shown in FIG. 9, the attachment method selected to attach the individual sealed fusible packets 200 to the internal framework 132 is intended to remain strong at temperatures above the point at which the individual sealed fusible packets 200 fuse and release the fire suppressing chemical agent. In an alternative embodiment as shown in FIG. 10, the individual sealed fusible packets 200 are attached to the internal framework by a means such as a fusible or thermally sensitive adhesive or fusible or thermally sensitive mechanical fasteners which release the individual sealed fusible packets 200 from the cells of the internal framework 132 at a temperature at or below the temperature at which the individual sealed fusible packets 200 fuse and release the fire suppressing chemical agent. In this embodiment of the “Type II” panel, the attachment method used to attach the individual sealed fusible packets 200 to the cells of the internal framework 132 would preferably be selected to release the individual sealed fusible packets 200 from the cells of the internal framework 132 at a temperature at or below the temperature at which the caps 212 release from the cells of the internal framework 132, but above the maximum temperatures that the panels would be exposed to in the absence of a fire. The individual sealed fusible packets 200 are then deployed on a tether 230, which is configured to suspend the individual sealed fusible packets 200 at a preselected height above the fire, where they will release their fire-suppressing chemicals closer to the floor. The material from which the individual sealed fusible packets 200 are constructed are necessarily incompatible with high temperatures involved in the conventional manufacturing process for the frame 110, and so are attached at a later stage, after the frame 110 is sufficiently cooled and dry.

The fire suppressing chemical agent contained within the individual sealed fusible packets 200 is preferably a powdered chemical fire extinguishing agent such as ABC powder or Purple K, and the individual sealed fusible packets 200 provide a barrier to moisture that could cause clumping or caking of these generally hygroscopic chemicals during their long term storage in the panel. Additional means to stabilize and ensure performance of the fire suppressing chemical agent, such as the addition of weighting agents, such as sand or calcium carbonate; desiccants, such as tricalcium phosphate, silica gel, diatomaceous earth, or acid-leached bentonite; and anti-caking agents, such as mica, attapulgite clay, or fumed silica; may be combined with the fire-suppressing chemicals.

FIG. 8 depicts a partially exploded perspective view of fire-suppressing drywall panels constructed according to another embodiment of the invention. This view is another angle of the view of the “Type II” fire-suppressing drywall panel shown in FIG. 7, illustrating the caps 212 and cap border 214 as a unitary facing cap layer 210, and the trays 130 and internal framework 132 installed in the voids 112 in the frame 110, with the individual sealed fusible packets 200 beneath the facing cap layer 210, positioned to be installed in the cells of the internal framework 132.

FIG. 9 depicts a detail perspective view illustrating the release of the cap 212 of a single fire suppressing cell according to an embodiment of the invention. For the sake of simplicity of illustration and understanding, a single cell of a Type II panel is shown activated, but if temperature conditions near the panel's bottom surface are sufficiently elevated to activate one cell, many if not all adjacent cells in the panel would also be activated in a similar manner. Upon the outbreak of a fire in room or other space having Type II panels installed in its ceiling, hot gases from combustion rise to the ceiling, raising the temperature of the air near the ceiling. Fusible or thermally sensitive adhesive or fusible or thermally sensitive mechanical fasteners attaching the cap 212 to the internal framework 132 fuse, causing the cap 212 to fall via gravity, exposing the individual sealed fusible packet 200 within the cell of the internal framework 132 beneath the cap 212. Exposed to hot gases from combustion, the individual sealed fusible packet 200 within the cell of the internal framework 132 subsequently fuses, releasing its contents, a fire suppressing chemical agent, onto the fire below via gravity. As stated earlier, in a typical fire, large numbers of fire suppressing cells in the internal framework would be similarly activated, releasing their fire suppressing chemical agent onto the fire below. Activation of the fire suppressing cells would be localized to those areas where the temperatures near the ceiling exceeded the temperature required to fuse the attachment means for the cap 212 and to fuse the fusible packet 200. Fire-suppressing chemical agent would thus be applied automatically where it was most needed, without the need for extensive plumbing or a source of water pressure as in typical fire sprinkler system.

FIG. 10 depicts a detail perspective view illustrating the deployment of a tethered packet from a single fire suppressing cell following release of the cap according to an embodiment of the invention. In this alternative embodiment of the Type II panel, the attachment means holding the individual sealed fusible packet 200 within the cell of the internal framework 132 is also configured to fuse, and the individual sealed fusible packet 200 is attached to the tray 130 by a tether 230. For the sake of simplicity of illustration and understanding, a single cell of a Type II panel is shown activated, but if temperature conditions near the panel's bottom surface are sufficiently elevated to activate one cell, many if not all adjacent cells in the panel would also be activated in a similar manner. Upon the outbreak of a fire in room or other space having Type II panels installed in its ceiling, hot gases from combustion rise to the ceiling, raising the temperature of the air near the ceiling. Fusible or thermally sensitive adhesive or fusible or thermally sensitive mechanical fasteners attaching the cap 212 to the internal framework 132 fuse, causing the cap 212 to fall via gravity, exposing the individual sealed fusible packet 200 within the cell of the internal framework 132 beneath the cap 212. Exposed to hot gases from combustion, the attachment means holding individual sealed fusible packet 200 within the cell of the internal framework 132, such as fusible or thermally sensitive adhesive or fusible or thermally sensitive mechanical fasteners, subsequently fuses, deploying the fusible packet 200, which is attached to a tether 230. The tether 230 causes the fusible packet 200 to be suspended at a predetermined distance above the fire, where exposed to hot gases from combustion, the individual sealed fusible packet will fuse and release its contents, a fire suppressing chemical agent, onto the fire below via gravity. The tether 230 may also be configured to mechanically rupture the fusible packet 200 when the end of the tether 230 is reached, such as by ripping open a tear strip, or triggering other mechanical means to rupture the fusible packet 200. As stated earlier, in a typical fire, large numbers of fire suppressing cells in the internal framework would be similarly activated, deploying their fusible packets 200 on tethers 230, and releasing their fire suppressing chemical agent in close proximity to the fire below. Activation of the fire suppressing cells would be localized to those areas where the temperatures near the ceiling exceeded the temperature required to fuse the attachment means for the cap 212 and the attachment means for the fusible packet 200, and to fuse the fusible packet 200. Fire-suppressing chemical agent would thus be applied automatically where it was most needed, without the need for extensive plumbing or a source of water pressure as in typical fire sprinkler system.

FIG. 11 depicts a detail perspective view of an alternative internal framework including integral attachment points 134 for fastener installation, according to an embodiment of the invention. To facilitate installation of the fire-suppressing drywall panels, the internal framework 132 may be configured to include integral attachment points 134 for use with conventional drywall fasteners, such as drywall nails or screws. The location of the integral attachment points 134 may be marked on the bottom surface of the panel, and in a preferred embodiment these markings may be made to be easily hidden or removed once the panels are installed, such as by wiping them off with a solvent, or painting over them.

FIG. 12 depicts a partially exploded perspective view illustrating an installation technique for fire-suppressing drywall panels constructed according to an embodiment of the invention. For convenience, and to further illustrate the internal framework 132 with integral attachment points 134 as shown in FIG. 11, only the frame 110, trays 130, and internal framework 132 of the fire-suppressing drywall panel are shown, components that are common between the Type I and Type II fire-suppressing drywall panels. Although having the fire suppressing chemicals contained within sealed packets (as in “Type II”) or fire suppression packets (as in “Type I”) helps to limit spillage of the fire suppressing chemicals during installation of the fire-suppressing drywall panels, it is still desirable to minimize the necessity of cutting the fire-suppressing drywall panels. One way to do this is to install uncut fire-suppressing drywall panels towards the center of a ceiling, making any necessary cuts in conventional drywall panels 300 installed towards the periphery of a ceiling. However, in order to provide sufficient internal volume of fire suppressing chemicals to achieve a desired level of fire protection in some applications, the thickness of fire suppressing drywall panels according to the invention may exceed the standard thickness of conventional drywall 300. To accommodate this difference, furring strips 302 may be attached to the ceiling joists 400 above the conventional drywall 300 in order to bring the bottom surface of thinner conventional drywall panels 300 even to the bottom surface of the thicker fire-suppressing drywall panels. It should be noted that the number of trays 130 and internal frameworks 132 that are depicted installed in the frame 110 here is six, rather than the four shown previously, and that the present invention anticipates that the number of these components may vary as necessary or desired for particular configurations. In a preferred embodiment, the voids in the frame 110 into which the trays 130 containing the internal frameworks 132 are installed are configured to be located between the ceiling joists 400, but if necessary or desired for a particular configuration, integral attachment points 134 in the internal framework 132 may be used to facilitate fastener installation through the fire suppressing units, rather than through the frame 110, without puncturing the fire suppression packets or packets containing the fire-suppressing chemical agent.

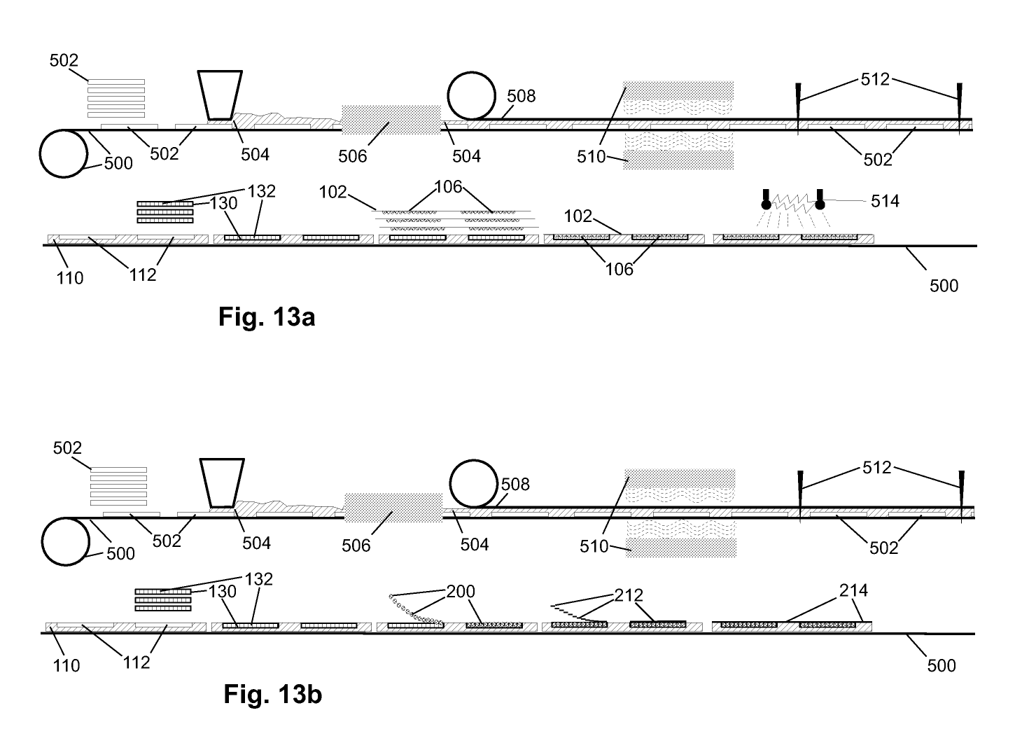

FIG. 13a depicts a schematic representation of a manufacturing process for producing fire suppressing drywall panels according to an embodiment of the invention. Specifically, the process illustrated may be used to manufacture the Type I fire suppressing drywall panels. Analogous methods may be used to manufacture Type I fire-suppressing suspended ceiling tiles such as those depicted in FIGS. 1 and 2. The voids into which the trays containing the internal framework will later be placed may be created by molding, an initial step of which is the placement of heat-resistant forms 502 on a conveyor 500. The conveyor 500 may have sidewalls in order to retain the gypsum slurry 504 that is poured over the forms 502. The thickness of the forms 502 and the height of the conveyor 500 sidewalls may vary, with the thickness of the forms 502 selected to create voids of a desired depth, and the conveyor 500 sidewalls selected to be a height corresponding to the desired thickness of the panel. The gypsum slurry 504, which may be formulated and applied to the mold as is known in the art, may then be smoothed 506 to a uniform thickness. A layer of facing paper 508, as is known in the art, may be applied to the smoothed gypsum slurry 504, which will eventually become the upper surface of the panel as installed. The mold conveyor 500 then travels through a drying stage 510, resulting in a paper-backed layer of gypsum that is firm enough to be cut 512 into boards, and which contains forms 502 that may be removed in order to facilitate further drying. These gypsum drywall boards with voids molded into them form the frames of the fire-suppressing drywall panels. Once the gypsum drywall frames have dried, and the heat-resistant forms 502 have been removed, the frames are inverted onto a conveyor 500, and the trays 130 containing the internal framework 132 are installed within the voids 112 that were cast into the frame 110. The fusible layer 102 with its fire suppression packets 106 containing the fire-suppressing chemical agent is then attached to the frame 110 and the internal framework 132. The Type I fire-suppressing drywall panels may undergo subsequent surface treatment 514, such as plasma or corona discharge treatment, as is known in the art, to prepare their lower surfaces to accept coatings such as paints or primers, or printing, such as the markings designating the locations of integral attachment points described with regard to FIG. 11, above.

FIG. 13b depicts a schematic representation of a manufacturing process for producing fire suppressing drywall panels according to another embodiment of the invention. Specifically, the process illustrated may be used to manufacture the Type II fire suppressing drywall panels. Analogous methods may be used to manufacture Type II fire-suppressing suspended ceiling tiles such as those depicted in FIGS. 1 and 2. The voids into which the trays containing the internal framework will later be placed may be created by molding, an initial step of which is the placement of heat-resistant forms 502 on a conveyor 500. The conveyor 500 may have sidewalls in order to retain the gypsum slurry 504 that is poured over the forms 502. The thickness of the forms 502 and the height of the conveyor 500 sidewalls may vary, with the thickness of the forms 502 selected to create voids of a desired depth, and the conveyor 500 sidewalls selected to be a height corresponding to the desired thickness of the panel. The gypsum slurry 504, which may be formulated and applied to the mold as is known in the art, may then be smoothed 506 to a uniform thickness. A layer of facing paper 508, as is known in the art, may be applied to the smoothed gypsum slurry 504, which will eventually become the upper surface of the panel as installed. The mold conveyor 500 then travels through a drying stage 510, resulting in a paper-backed layer of gypsum that is firm enough to be cut 512 into boards, and which contains forms 502 that may be removed in order to facilitate further drying. These gypsum drywall boards with voids 112 molded into them form the frames 110 of the fire-suppressing drywall panels. Once the gypsum drywall frames have dried, and the heat-resistant forms 502 have been removed, the frames are inverted onto a conveyor 500, and the trays 130 containing the internal framework 132 are installed within the voids 112 that were cast into the frame 110. The individual sealed fusible packets are then installed within the cells of the internal framework 132, and may be attached to the tray via tethers, as described with regard to FIG. 10, above. The caps 212 and cap border 214 are attached to the panels, sealing the cells of the internal framework 132, and forming the cap layer which is the bottom surface of the Type II fire-suppressing drywall panel. The Type II fire-suppressing drywall panels may undergo subsequent surface treatment, such as to conceal the seams between the caps, and to produce a lower surface having a smooth, finished appearance.

Although the invention has been shown and described with reference to certain specific presently preferred embodiments, the given embodiments should not be construed as limitations on the scope of the invention, but as illustrative examples, and those skilled in the art to which this invention pertains will undoubtedly find alternative embodiments obvious after reading this disclosure. With this in mind, the following claims are intended to define the scope of protection to be afforded the inventor, and these claims shall be deemed to include equivalent constructions insofar as they do not depart from the spirit and scope of the present invention.

### REFERENCE NUMERALS

100 Unitary fusible facing layer
102 Fusible layer
104 Flange
106 Fire suppression packets
110 Frame
112 Void
114 Facing paper
120 Fire suppressing unit
130 Tray
132 Internal framework
134 Integral attachment points
200 Fire suppression packets
210 Facing cap layer
212 Caps
214 Cap border
220 Fire suppressing unit
230 Tether
300 Drywall
302 Furring strips
400 Ceiling joists
500 Conveyor
502 Heat-resistant forms
504 Gypsum slurry
506 Smoothing stage
508 Facing paper
510 Drying stage
512 Cutting stage
514 Surface treatment

We claim:

1. A fire suppressing ceiling panel, comprising:
a frame comprising at least one void;
a fire suppressing unit mounted within each at least one void of said frame, said fire suppressing unit comprising
an internal framework defining a plurality of cells,
said internal framework covered by a facing layer mounted to said internal framework by a first mounting means,
each of said plurality of cells containing a fire suppression packet mounted within by a second mounting means,
said fire suppression packet comprising a sealed fusible nonpermeable film containing a fire suppressing material, said sealed fusible nonpermeable film having a predetermined melting temperature above the maximum temperature that the fire suppressing ceiling panel would be exposed to in the absence of a fire, and below the temperature of combustion of the sealed fusible nonpermeable film.

2. The fire suppressing ceiling panel of claim 1, wherein the fire suppressing material comprises a powdered fire suppressing chemical agent.

3. The fire suppressing ceiling panel of claim 1, wherein the facing layer comprises a fusible nonpermeable film formed to be unitary with the sealed fusible nonpermeable film comprising the fire suppression packet mounted within each of the plurality of cells of the fire suppressing unit.

4. The fire suppressing ceiling panel of claim 1, wherein the facing layer comprises a plurality of caps, each of said plurality of caps covering one of the plurality of cells defined by the internal framework.

5. The fire suppressing ceiling panel of claim 2, wherein the facing layer comprises a fusible nonpermeable film formed to be unitary with the sealed fusible nonpermeable film comprising the fire suppression packet mounted within each of the plurality of cells of the fire suppressing unit.

6. The fire suppressing ceiling panel of claim 2, wherein the facing layer comprises a plurality of caps, each of said plurality of caps covering one of the plurality of cells defined by the internal framework.

7. The fire suppressing ceiling panel of claim 3, wherein the fusible nonpermeable film comprising the facing layer and the sealed fusible nonpermeable film comprising the fire suppression packet are configured to fuse at a predetermined melting temperature above the maximum temperature that the fire suppressing ceiling panel would be exposed to in the absence of a fire, and below the temperature at which the frame, the internal framework of the fire suppressing unit, and the second mounting means would fail to support the weight of any of the fire suppression packets mounted within the fire suppressing unit.

8. The fire suppressing ceiling panel of claim 5, wherein the fusible nonpermeable film comprising the facing layer and the sealed fusible nonpermeable film comprising the fire suppression packet are configured to fuse at a predetermined melting temperature above the maximum temperature that the fire suppressing ceiling panel would be exposed to in the absence of a fire, and below the temperature at which the frame, the internal framework of the fire suppressing unit, and the second mounting means would fail to support the weight of any of the fire suppression packets mounted within the fire suppressing unit.

9. The fire suppressing ceiling panel of claim 4, wherein the first mounting means is fusible at a predetermined melting temperature at or below the temperature at which the sealed fusible nonpermeable film comprising the fire suppression packets fuses, but above the maximum temperature that the fire suppressing ceiling panel would be exposed to in the absence of a fire.

10. The fire suppressing ceiling panel of claim 6, wherein the first mounting means is fusible at a predetermined melting temperature at or below the temperature at which the sealed fusible nonpermeable film comprising the fire suppression packets fuses, but above the maximum temperature that the fire suppressing ceiling panel would be exposed to in the absence of a fire.

11. The fire suppressing ceiling panel of claim 9, wherein the second mounting means is configured to support the weight of each fire suppression packet at a predetermined temperature above the temperature at which the sealed fusible nonpermeable film comprising the fire suppression packet fuses.

12. The fire suppressing ceiling panel of claim 10, wherein the second mounting means is configured to support the weight of each fire suppression packet at a predetermined temperature above the temperature at which the sealed fusible nonpermeable film comprising the fire suppression packet fuses.

13. The fire suppressing ceiling panel of claim 9, wherein the second mounting means comprises a tethering means configured to connect the fire suppression packet to the internal framework of the fire suppression unit, and an attachment means having a predetermined melting temperature at or below the temperature at which the sealed fusible nonpermeable film comprising the fire suppression packet fuses, but above the maximum temperature that the fire suppressing ceiling panel would be exposed to in the absence of a fire.

14. The fire suppressing ceiling panel of claim 10, wherein the second mounting means comprises a tethering means configured to connect the fire suppression packet to the internal framework of the fire suppression unit, and an attachment means having a predetermined melting temperature at or below the temperature at which the sealed fusible nonpermeable film comprising the fire suppression packet fuses, but above the maximum temperature that the fire suppressing ceiling panel would be exposed to in the absence of a fire.

15. The fire suppressing ceiling panel of claim 7, wherein the internal framework further comprises a plurality of predetermined integral mounting points where mechanical fasteners may be attached without piercing the fire suppression packet.

16. The fire suppressing ceiling panel of claim 8, wherein the internal framework further comprises a plurality of predetermined integral mounting points where mechanical fasteners may be attached without piercing the fire suppression packet.

17. The fire suppressing ceiling panel of claim 11, wherein the internal framework further comprises a plurality of predetermined integral mounting points where mechanical fasteners may be attached without piercing the fire suppression packet.

18. The fire suppressing ceiling panel of claim 12, wherein the internal framework further comprises a plurality of predetermined integral mounting points where mechanical fasteners may be attached without piercing the fire suppression packet.

19. The fire suppressing ceiling panel of claim 13, wherein the internal framework further comprises a plurality of predetermined integral mounting points where mechanical fasteners may be attached without piercing the fire suppression packet.

20. The fire suppressing ceiling panel of claim 14, wherein the internal framework further comprises a plurality of predetermined integral mounting points where mechanical fasteners may be attached without piercing the fire suppression packet.
